(19) United States
(12) Patent Application Publication
(10) Pub. No.: US 2006/0269345 A1
(43) Pub. Date: Nov. 30, 2006

(54) RIBBON CARTRIDGE CAPABLE OF PROVIDING A TENSION FORCE TO A RIBBON AT ONE END OF A RIBBON-FEEDING BAY

(76) Inventors: Chui-Chien Chiu, Taipei City (TW); Wen-Chuan Wang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/162,604

(22) Filed: Sep. 16, 2005

(30) Foreign Application Priority Data
May 24, 2005 (TW) 094116887

(51) Int. Cl. B41J 17/24

(52) U.S. Cl. 400/234

(57) ABSTRACT

A ribbon cartridge provides a tension mechanism to a ribbon inside the cartridge. By installing a frictional piece on one end of a ribbon-feeding bay of the ribbon cartridge, a feeding roller contacts the frictional piece and the frictional piece provides a frictional force for applying sufficient tension on the ribbon.

### BACKGROUND OF THE INVENTION

1. Field of the Invention

The present invention relates to a ribbon cartridge, and more particularly, to a ribbon cartridge capable of providing a tension force to a ribbon at one end of a ribbon-feeding bay.

2. Description of the Prior Art

Most ink jet printers are used in half tone mode, which fails to show continuous hues found in real photo pictures. Therefore, a thermal printer, which is used in full tone mode, has become popular.

The material of the ribbon used in the thermal printer is a transparent celluloid paper with wax and color dyes, taking the thermal printer sublimating color dyes on a photo picture for an example. The thermal print head heats the wax and color dyes on the ribbon, and due to the temperature change, the color dye is temporarily liquefied and is transferred onto the photo paper. Then, the color dyes are cooled and thus fixed on the photo paper to impart a colorful image.

Therefore, the quality of the ribbon could tremendously affect the printing quality. Generally, the structure of the ribbon used in the thermal printer has two exposed ribbon rollers or a ribbon cartridge accommodating ribbon rollers. The ribbon rollers have a feeding roller and a driving roller, where the driving roller revolves to roll up used ribbon during printing. In order to guarantee good printing quality, the ribbon must be smooth during printing. Thus, there is a flexible mechanism positioned at an end of the roller for locating the feeding roller and the driving roller, preventing the ribbon from a displacement. In addition, there is a torque restriction mechanism positioned at an end of the feeding roller for applying a proper tension force on the ribbon, preventing the ribbon from being creased.

Please refer to FIG. 1, which is an illustration of a torque restriction mechanism 40 in a ribbon cartridge 10 according to the prior art. The ribbon cartridge 10 comprises a feeding roller 20 and a driving roller 30. A restriction gear 22 positioned at an end of the feeding roller 20 engages the torque restriction mechanism 40. The torque restriction mechanism 40 provides a torque revolving in the opposite direction to the rolling direction of the ribbon for restricting revolution of the feeding roller 20 while the driving roller 30 is rolling. This applies a required tension force on the ribbon during printing.

A flexible mechanism 24 at each roller 20, 30 is only for axial location of each roller 20, 30. However, the flexible mechanism 24 cannot apply a fixed force to fix each roller 20, 30, resulting in the rollers 20 and 30 being displaced easily due to the vibration while carrying the printer. Additionally, the tension force applied on the ribbon during printing is provided by the torque restriction mechanism 40, but it is not easy to control the tension force because of the differences in machines and structural tolerances of different ribbon cartridges 10. The torque restriction mechanism 40 not only complicates the structure of the printer, but also increases costs during manufacture.

### SUMMARY OF THE INVENTION

It is therefore a primary objective of the claimed invention to provide a ribbon cartridge capable of providing a tension force to a ribbon at an end of a ribbon-feeding bay to solve the above-mentioned problems.

The claimed invention provides a ribbon cartridge capable of providing a tension force to a ribbon at an end of a ribbon-feeding bay. The ribbon cartridge includes a frame comprising a ribbon-feeding bay and a ribbon-driving bay, a feeding roller positioned inside the ribbon-feeding bay of the frame for installing the ribbon, a driving roller positioned inside the ribbon-driving bay of the frame for retrieving the ribbon transported from the feeding roller while the driving roller revolves, a frictional piece positioned at a first end of the feeding roller for providing a friction force by contacting a rolling piece of the feeding roller, and a flexible mechanism positioned at a second end of the ribbon-feeding bay for pressing an end of the feeding roller to push the rolling piece toward the frictional piece.

The claimed invention also provides a ribbon cartridge capable of providing a tension force to a ribbon at an end of a ribbon-feeding bay. The ribbon cartridge includes a frame having a ribbon-feeding bay and a ribbon-driving bay, a first end of the ribbon-feeding bay including a rough surface, a feeding roller positioned inside the ribbon-feeding bay of the frame for installing the ribbon, a driving roller positioned inside the ribbon-driving bay of the frame for retrieving the ribbon transported from the feeding roller while the driving roller revolves, and a flexible mechanism positioned at a second end of the ribbon-feeding bay for pressing an end of the feeding roller to push a rolling piece of the feeding roller toward the rough surface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration of a torque restriction mechanism in a ribbon cartridge according to the prior art.

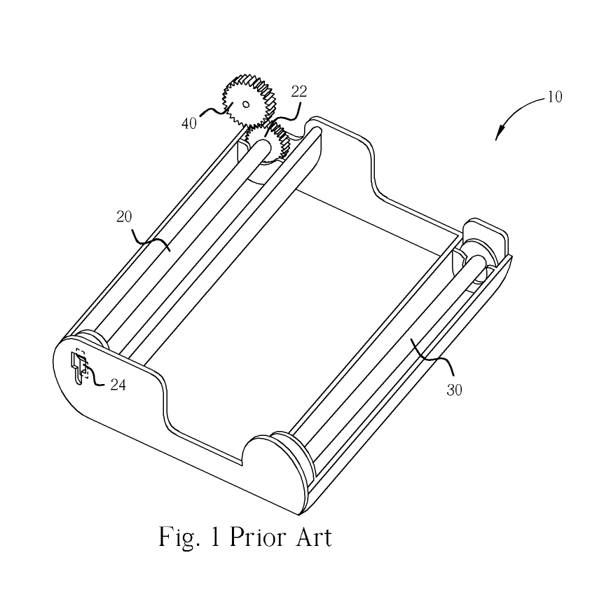

FIG. 2 is an illustration of a first embodiment of a ribbon cartridge of the present invention.

FIG. 3 is a force illustration when the feeding roller of FIG. 2 contacts the frictional piece.

FIG. 4 is an illustration of a second embodiment of a ribbon cartridge of the present invention.

### DETAILED DESCRIPTION

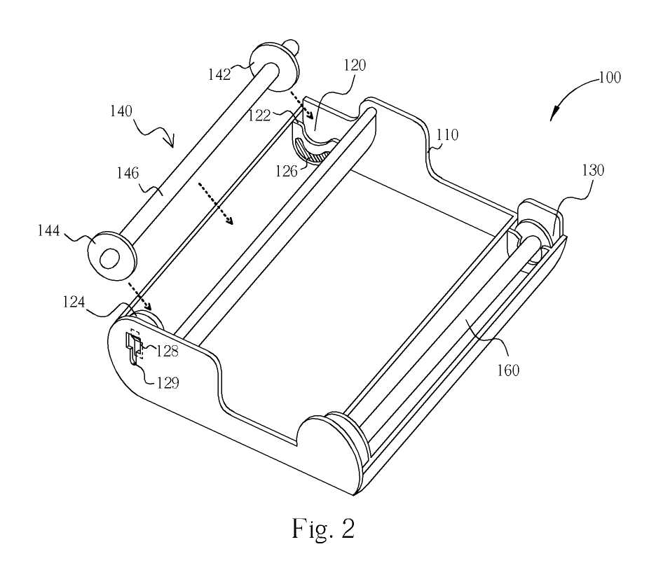

Please refer to FIG. 2, which is an illustration of a first embodiment of a ribbon cartridge 100 of the present invention. The ribbon cartridge 100 comprises a frame 110, a feeding roller 140, a driving roller 160, a frictional piece 126, and a flexible mechanism 128. The frame 110 comprises a ribbon-feeding bay 120 for accommodating the feeding roller 140, and a ribbon-driving bay 130 for accommodating the driving roller 160. The feeding roller 140 comprises a revolving spindle 146, and two rolling pieces 142 and 144 respectively positioned at each end of the feeding roller 140. Since an end of the ribbon is connected to the driving roller 160, revolving the driving roller 160 enables the ribbon to advance. Also, the feeding roller 140 revolves with the movement of the ribbon. This is the motion of the ribbon.

While the feeding roller 140 is placed inside the ribbon-feeding bay 120, the flexible mechanism 128 positioned inside a hole 129 at a second end 124 of the ribbon-feeding bay 120 presses the rolling piece 144 to push the feeding roller 140 toward to the other side so that the rolling piece 142 closely contacts a first end 122 of the ribbon-feeding bay 120.

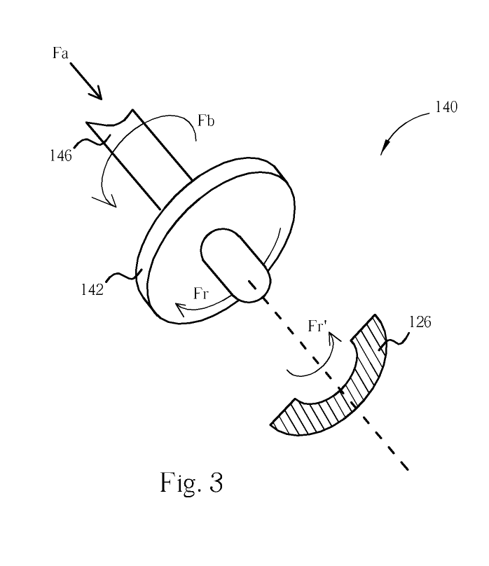

Please refer to FIG. 3, which is a force illustration when the feeding roller 140 contacts the frictional piece 126. In the prior art, there is no effective friction force at the feeding roller 140 and the driving roller 120, and thereby an additional torque restriction mechanism is used for providing a restriction force. Thus, the present invention installs the frictional piece 126 at the first end 122 of the ribbon-feeding bay 120. When the rolling piece 142 closely contacts the frictional piece 126 at the first end 122 resulting from the flexible mechanism 128 providing a force Fa to the feeding roller 140, a pair of static friction forces Fr and Fr′ with opposite directions is generated. Since the ribbon is spooled at the feeding roller 140 and the static friction force Fr between the feeding roller 140 and the frictional piece 126 is smaller than the revolving force Fb, the feeding roller 140 is driven by the movement of the ribbon to revolve in the direction of the revolving force Fb, as shown in FIG. 3. Additionally, while the feeding roller 140 revolves, the dynamic friction force Fr exists between the rolling piece 142 and the frictional piece 126, providing a force in opposite direction to that of the movement of the ribbon so that the ribbon has a consistent tension while being rolled.

While the driving roller 160 stops rolling the ribbon, the revolving force Fb of the feeding roller 140 disappears consequentially. Due to static friction forces Fr and Fr′, there is no relative torque between the frictional piece 126 and the rolling piece 142. Therefore, the feeding roller 140 is kept at an un-revolving state and the required tension is provided to the ribbon while the ribbon does not advance.

The ribbon cartridge 100 of the present invention provides the required tension to the ribbon via the frictional piece 126. The frictional piece 126 may be shaped similar to a half-moon, providing an appropriate frictional force according to the contacting areas. The frictional coefficient of the frictional piece 126 can be adjusted depending on the required frictional force. Additionally, the flexible mechanism 128 in the ribbon-feeding bay 120 can be a flexible piece or a spring.

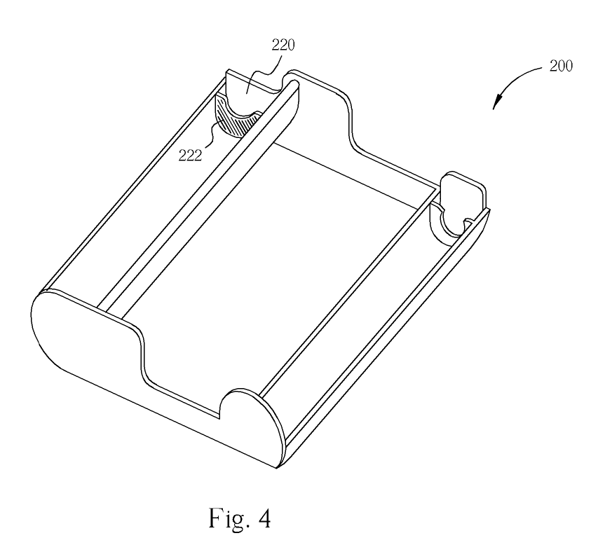

FIG. 4 is an illustration of a second embodiment of a ribbon cartridge 200 of the present invention. The difference from the first embodiment is that there is no frictional piece positioned at the first end 122 of the ribbon-feeding bay 220. Instead, the first end includes a rough surface for providing the same effect of the frictional piece 126. The other parts of the second embodiment are the same as those of the first embodiment, and thereby the details are omitted.

To sum up, with the frictional piece 126 positioned inside the ribbon-feeding bay 120, the present invention can apply a sufficient tension on the ribbon. The present invention not only does not require the torque restriction mechanism of the prior art, but also solves the prior art problem of tolerances where the tension mechanism is positioned outside the ribbon cartridge.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A ribbon cartridge capable of providing a tension force to a ribbon at an end of a ribbon-feeding bay, the ribbon cartridge comprising:
a frame comprising a ribbon-feeding bay and a ribbon-driving bay;
a feeding roller positioned inside the ribbon-feeding bay of the frame for installing the ribbon;
a driving roller positioned inside the ribbon-driving bay of the frame for retrieving the ribbon transported from the feeding roller while the driving roller revolves;
a frictional piece positioned at a first end of the feeding roller for providing a frictional force by contacting a rolling piece of the feeding roller; and
a flexible mechanism positioned at a second end of the ribbon-feeding bay for pressing an end of the feeding roller to push the rolling piece toward the frictional piece.

2. The ribbon cartridge of claim 1 wherein the frictional piece is shaped as a half-moon.

3. The ribbon cartridge of claim 1 wherein the flexible mechanism is a flexible piece.

4. The ribbon cartridge of claim 1 wherein the flexible mechanism is a spring.

5. The ribbon cartridge of claim 1 wherein the flexible mechanism is positioned in a hole at the second end of the ribbon-feeding bay for pressing the end of the feeding roller to push the rolling piece toward the frictional piece.

6. A ribbon cartridge capable of providing a tension force to a ribbon at an end of a ribbon-feeding bay, the ribbon cartridge comprising:
a frame comprising a ribbon-feeding bay and a ribbon-driving bay, a first end of the ribbon-feeding bay including a rough surface;
a feeding roller positioned inside the ribbon-feeding bay of the frame for installing the ribbon;
a driving roller positioned inside the ribbon-driving bay of the frame for retrieving the ribbon transported from the feeding roller while the driving roller revolves; and
a flexible mechanism positioned at a second end of the ribbon-feeding bay for pressing an end of the feeding roller to push a rolling piece of the feeding roller toward the rough surface.

7. The ribbon cartridge of claim 6 wherein the rough surface is shaped as a half-moon.

8. The ribbon cartridge of claim 6 wherein the flexible mechanism is a flexible piece.

9. The ribbon cartridge of claim 6 wherein the flexible mechanism is a spring.

10. The ribbon cartridge of claim 6 wherein the flexible mechanism positioned in a hole at the second end of the ribbon-feeding bay for pressing the end of the feeding roller to push the rolling piece of the feeding roller toward the rough surface.
